(19) United States
(12) Patent Application Publication
(10) Pub. No.: US 2007/0247050 A1
(43) Pub. Date: Oct. 25, 2007

(54) Electric Lamp Comprising a Light Absobing Medium

(75) Inventors: Hans Van Spang, Eindhoven (NL); Christian Balac, Chartres (FR); Jean-Rene Cotel, Saint Andre de I'Eure (FR)

Correspondence Address: PHILIPS INTELLECTUAL PROPERTY & STANDARDS, P.O. BOX 3001, BRIARCLIFF MANOR, NY, 10510, US

(73) Assignee: KONINKLIJKE PHILIPS ELECTRONICS, N.V., EINDHOVEN (NL)

(21) Appl. No.: 11/573,783

(22) PCT Filed: Aug. 10, 2005
(86) PCT No.: PCT/IB05/52659

§ 371 Date: Feb. 16, 2007

(30) Foreign Application Priority Data
Aug. 20, 2004 (EP) 04104007.2

(51) Int. Cl. H01J 5/08

(52) U.S. Cl. 313/317

(57) ABSTRACT

The invention relates to an electric lamp comprising a light-transmitting pear shaped lamp vessel (1) with a top part (8) and a centre part (9) in which a light source (2) is arranged in the centre part, said electric lamp provided with a light-absorbing medium (6) exhibiting a spectral transition in the visible range, at least a part of the lamp vessel (1) being provided with an interference film (5), wherein the light absorbing-medium (6) provided at the top part of the vessel (8) has an absorption, which is 1.5 to 5 times the absorption of the light-absorbing medium provided at the centre part (9) of the vessel.

The invention relates to an electric lamp comprising a light-transmitting pear shaped (P) lamp vessel with a top part and a center part, in which a light source is arranged, said electric lamp is provided with a light-absorbing medium exhibiting a spectral transition in the visible range, at least a part of the lamp vessel comprising an interference film.

Such lamps are used in automotive applications as an amber-colored light source in indicators (also referred to as vehicle signal lamps) or as a red-colored light source in brake lights. Such electric lamps are also used for general illumination purposes. Said electric lamps are further used in traffic and direction signs, contour illumination, traffic lights, projection illumination and fiber optics illumination. Alternative embodiments of such lamps comprise lamps wherein the color temperature is increased by means of a suitable combination of the light-absorbing medium and the interference film.

In vehicles it is desirable, for esthetical reasons, to provide indicator lamps and brake lights with a color-neutral appearance Only when the electric lamp is activated, it shows the desired color, whereby the color point of the light emitted by the electric lamp meets statutory regulations. Moreover, in vehicles there is a tendency to accommodate amber-colored indicator lamps in the same reflector as the headlamp instead of in a separate reflector. In addition, the aim is to use luminaires in cars, which are provided with so-called “clear covers”, i.e. an observer situated outside the vehicle can directly see the indicator lamps or brake lamps in the luminaire. For reasons of safety, it is important that, apart from a color-neutral appearance, such indicator lamps are at least substantially free of coloring in reflection at light which is (accidentally) incident on the electric lamp. If, for example, sunlight or light originating from on-coming traffic is incident on a headlamp of a vehicle comprising an indicator lamp, the appearance of said headlamp, in reflection, should be at least substantially colorless or, in reflection, said lamp should emit at least substantially no color. Otherwise, this might confuse other road users and give rise to unsafe and/or undesirable situations.

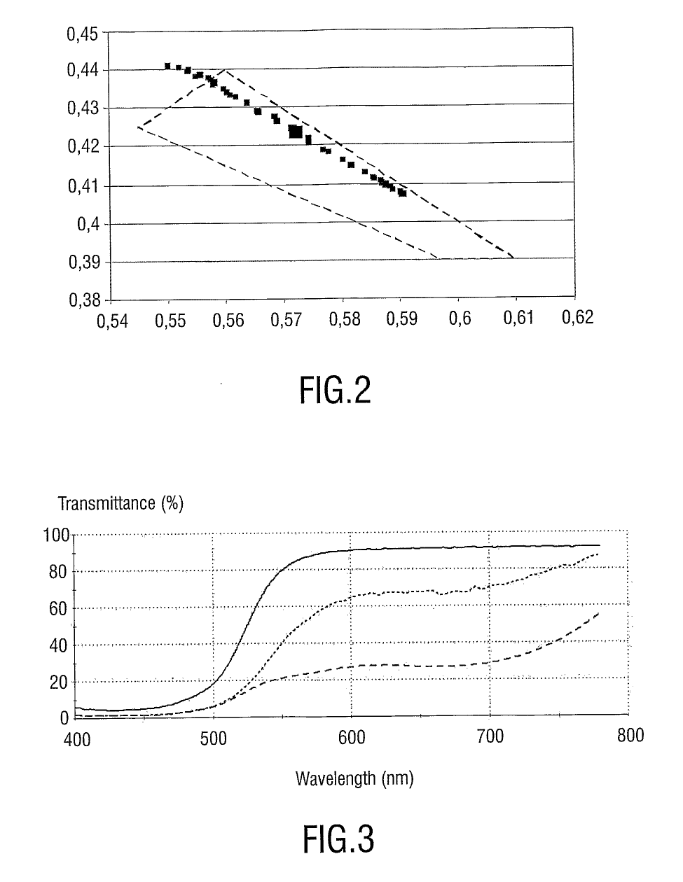

Statutory regulations define a range, in the 1931 C.I.E. color triangle known to those skilled in the art, and depicted in FIG. 2 for the color point of the light emitted by such indicator lamps. A suitable combination of a light-absorbing medium and an interference film applied to an outside surface of the lamp vessel enables the appearance of the electric lamp to be changed. This particularly enables a distinction to be made between the appearance of the electric lamp in the off state and the color of the light emitted by the electric lamp during operation.

In reflection, the spectral characteristic of the electric lamp in accordance with the invention differs from the spectral characteristic in transmission. In transmission, the light emitted by the electric lamp meets statutory regulations with respect to the color point, while, in reflection, the electric lamp is color-neutral, the appearance of the electric lamp being, for example, silvery. The current invention applies, in particular, to indicator lamps and brake lights of vehicles.

An electric lamp of the type mentioned in the opening paragraph is known from WO-A-01/97253 (PHN 031400). The known lamp emits a certain color, for example a so-called amber-colored or red-colored electric lamp, while, in the off state, the electric lamp has an at least substantially color-neutral appearance.

A drawback of the known lamp is that the light emitted from the top is much lighter than the light emitted from the centre and bottom parts of the vessel, which results in an inhomogeneous color point distribution.

The aim of the invention is to provide a lamp with a more homogeneous color point distribution.

To achieve this, the electric lamp of the type described in the opening paragraph has the characterizing features of claim 1.

The application of the light absorbing-medium (6) provided at the top part of the vessel (8) having an absorption that is between 1.5 and 5 times the absorption of the light-absorbing medium provided at the center part (9) of the vessel results in an electric lamp with an improved color point distribution.

It has been measured that the light output at the top (0<β<30 degrees) is significantly lighter than the light emitted by other parts of the lamp. The top part in this application is understood to be that part of the lamp vessel, which is within a cone with an angle β of at most 30 degrees with a central axis through the vessel. The center part of the lamp vessel has an angle β of between 30 and 150 degrees with the central axis. A bottom part of the lamp vessel is defined as that part which has an angle β of more than 150 degrees with the central axis towards a lamp base. It should be understood that there is no sharp transition between the top part, the center part and the bottom part and that the given angles are a rough indication, strongly dependent on the shape of the lamp and the distance between the light source and the top of the lamp. The top, center and bottom parts at least comprise areas on the vessel around β is 0 degrees, 90 degrees and the area closest to the lamp holder respectively.

As known from previous art (see e.g. WO 01/24224) the role of the interference coating on top of the absorbing layer is to shift the color point which is situated above the specifications to a value which is in the specified color zone. When e.g. a mirror is used with a reflectivity R=70%, it is implied that 30% of the light leaves the lamp after 1 pass through the absorbing medium while the other 70% will leave the lamp after multiple passes through the absorbing medium only. This results in a final color point that is shifted in the specified and required direction. The process is found to work well for the centre and bottom part of the lamp, but light emitted by the light source, e.g. the filament, towards the top will either pass directly (30%) or it will be reflected towards the base where it was found to be absorbed in the combination of glass and resin present to fix the lamp in the cap. Based on this insight we concluded, that in the area defined by 0<β<30 degrees the absorbing layer should have the property that with a single pass through it the emitted light should be darker than in the existing lamp thus falling in the required color point specification. The lamp of the invention therefore has a substantially smaller color point distribution than the known lamp.

An increase of the absorption can be obtained in two manners. One way is to increase the absorption coefficient of the light-absorbing medium for example by increasing the concentration of the light-absorbing medium. The preferred manner, however, is to increase the thickness of the layer comprising the light-absorbing medium.

An embodiment of an electric lamp in accordance with the invention is characterized in that a wall of the lamp vessel comprises the light-absorbing medium. Light absorbing media can be readily incorporated in the wall of the lamp vessel, which is made, for example, from glass, such as soft glass, quartz glass or hard glass, or from a transparent ceramic material. In this embodiment, the interference film is preferably directly applied to a side of the wall of the lamp vessel facing away from the light source.

A preferred embodiment of the electric lamp in accordance with the invention is characterized in that the light-absorbing medium is included in a light-absorbing layer, which is situated between the lamp vessel and the interference film. As the light-absorbing layer is arranged between the outside surface of the lamp vessel and the interference film, light, which is reflected by the interference film, passes the light-absorbing medium twice, which leads to a further improvement of the effectiveness of the absorption process. In addition, light that is reflected to and fro between the interference films on both sides of the lamp vessel passes the light-absorbing layer twice at each reflection.

The thickness t_{abs}, of the light-absorbing layer preferably lies in a range from 5 nm<t_{abs}<5000 nm. If the thickness of the light-absorbing layer is smaller than 5 nm, absorption hardly takes place and the intended shift of the color temperature is insufficiently achieved. If the thickness of the layer exceeds 5 μm, it becomes difficult to make a layer which does not crack or delaminate and which does not adversely effects the lumen output of the lamp. A light-absorbing layer having a thickness of 0.8<t_{abs}<2 μm provided at the centre part of the vessel is very suitable.

The light-absorbing layer generally comprises a light absorbing medium in a binder. A preferred embodiment of the electric lamp is characterized in that the binder comprises a network, which can be obtained by converting an organically modified silane by means of a sol-gel process, said organically modified silane being selected from the group formed by compounds of the structural formula R^{I}Si(OR^{II})₃, R^{I} comprising an alkyl group or an aryl group, and R^{II} comprising an alkyl group.

By making the light-absorbing layer from a network comprising an organically modified silane as the starting material, an optically transparent, non-scattering, light-absorbing layer is obtained which is capable of resisting temperatures up to 400° C. By using an organically modified silane in the manufacture of the network, a part of the R^{I} groups, the alkyl or aryl groups remains in the network as an end group. As a result, the network does not comprise four network bonds per Si atom, but less than four network bonds per Si atom. In this manner, for example, a network is obtained comprising, on average, approximately three network bonds per Si atom. In spite of the fact that the network is partly composed of said alkyl or aryl groups, a network is obtained whose density is at least substantially equal to that of the customary silica network. Unlike the customary silica network, a network, which is partly composed of said alkyl or aryl groups has a greater elasticity and flexibility. As a result, it becomes possible to manufacture comparatively thick light-absorbing layers.

Preferably, the R^{I} group comprises CH₃ or C₆H₅. These substances have a comparatively good thermal stability. A network comprising methyl or phenyl groups enables thicker layers to be obtained. Experiments have further shown that layers, wherein methyl or phenyl groups are incorporated in a network, are stable to a temperature of at least 350° C. Said groups form end groups in the network and remain part of the network at said higher temperatures. At such a comparatively high temperature load on the light-absorbing layer, no appreciable degradation of the network occurs during the service life of the electric lamp.

Preferably, the R^{II} group comprises CH₃ or C₂H₅. Methyl and ethyl groups are particularly suitable because methanol and ethanol are formed in the hydrolysis, which substances are compatible with the pigment dispersion and evaporate comparatively easily. In general, the methoxy groups (—OCH₃) react more rapidly than the ethoxy groups (—OC₂H₅), which in turn react more rapidly than (iso)propoxy groups (—OC₃H₇). For a smooth hydrolysis process, use is advantageously made of R^{II} groups, which are not too long.

Particularly suitable starting materials for the manufacture of the network are methyltrimethoxysilane (MTMS), wherein R^{I}=R^{II}=CH₃, methyltriethoxysilane (MTES), wherein R^{I}=CH₃ and R^{II}=C₂H₅, phenyltrimethoxysilane (PTMS), wherein R^{I}=C₆H₅ and R^{II}=CH₃, and phenyltriethoxysilane (PTES), wherein R^{I}=C₆H₅ and R^{II}=C₂U₅. Such starting materials are known per se and commercially available.

A preferred embodiment of the electric lamp is characterized in that the light-absorbing medium has an amber-colored or red-colored transmission. Electric lamps that, in operation, emit amber-colored light can particularly suitably be used as an indicator lamp in vehicles. Electric lamps that, in operation, emit red light are particularly suitable as brake lights in vehicles.

Preferably, the light-absorbing medium has an amber-colored transmission. A particularly suitable light-absorbing medium is chromophtal yellow, chemical formula C₂₂H₆C₁₈N₄O₂ and C.I. (constitution number) 56280. This organic dye is also referred to as “C.I.-110 yellow pigment”, “C.I. pigment yellow 137” or Bis[4,5,6,7-tetrachloro-3-oxoisoindoline-1-ylidene)-1,4-phenylenediamine. An alternative light-absorbing medium having an amber-colored transmission is yellow anthraquinone, chemical formula C₃₇H₂₁N₅O₄ and C.I. 60645. This organic dye is also referred to as “Filester yellow 2648A” or “Filester yellow RN”, chemical formula, 1,1′-[(6-phenyl-1,3,5-triazine-2,4diyl)diimino]bis-.

In an alternative embodiment, the light-absorbing medium has a red-colored transmission and comprises, by way of example, “chromophtal red A2B” with C.I. 65300. Said organic dye is alternatively referred to as “pigment red 177”, dianthraquinonyl red or as [1,1′-Bianthracene]-9,9′,10,10′-tetrone,4,4′-diamino-(TSCA, DSL).

An embodiment of the electric lamp in accordance with the invention is characterized in that the interference film comprises layers of, alternately, a first layer of a material having a comparatively high refractive index and a second layer of a material having a comparatively low refractive index. The use of two materials simplifies the provision of the interference film. In an alternative embodiment, at least a third layer is applied having a refractive index between that of the first layer and the second layer.

A preferred embodiment of the electric lamp in accordance with the invention is characterized in that the second layer of the interference film comprises predominantly silicon oxide, and the first layer of the interference film comprises predominantly a material having a refractive index that is high as compared to a refractive index of silicon oxide.

Layers of silicon oxide can be provided comparatively readily using various deposition techniques.

Preferably, the first layer of the interference film comprises a material chosen from the group formed by titanium oxide, tantalum oxide, zirconium oxide, niobium oxide, hafnium oxide, yttrium oxide, silicon nitride and combinations of said materials. Preferably, the material of the first layer of the interference film predominantly comprises niobium pentoxide, Tantalum pentoxide or Titanium dioxide.

Preferably, the interference films are Nb₂O₅/SiO₂ type films, Ta₂O₅/SiO₂ or TiO₂/SiO₂ type films or mixtures thereof and comprise, preferably, at least 3 and at most approximately 17 layers. As a result of the comparatively small number of layers, the manufacturing costs of such an interference film are comparatively low.

A preferred embodiment of the electric lamp in accordance with the invention is characterized in that the reflection R of the interference film lies in the range from 0.50<R<0.90 at least in the visual spectral range between about 380 and 780 nm. The reflection R is understood to be at least a reflection from a color lying in the visual spectral range. The reflection R can be the roughly the same for all frequencies in said range, or can be color neutral with a maximum of between 0.5 and 0.9. In this preferred embodiment, the interference film has a metallic or silvery appearance. As a result thereof, the electric lamp in accordance with the invention can very suitably be used as an indicator lamp for automotive applications.

The light source of the lamp may be an incandescent body, or it may be an electrode pair in an ionizable gas, for example an inert gas with metal halides, possibly with, for example, mercury as a buffer gas. Preferably the light source is a filament arranged in a plane perpendicular to a central axis (22) through the vessel. An innermost gastight envelope may surround the light source. It is alternatively possible, that an outermost envelope surrounds the lamp vessel.

The interference film and the light-absorbing layer may be provided in a customary manner by means of, for example, vapor deposition (PVD: physical vapor deposition) or by (dc) (reactive) sputtering or by means of a dip-coating or spraying process or by means of LP-CVD (low-pressure chemical vapor deposition), PE-CVD (plasma-enhanced CVD) or PI-CVD (plasma impulse chemical vapor deposition). The light-absorbing layer on the outer wall of the lamp vessel is preferably applied by means of dip coating or spraying. In a preferred embodiment of the electric lamp the thickness of the light-absorbing layer increases gradually from the centre part (9) to the top part (8). This can be obtained by spraying longer depending on the height above the centre part of the lamp or by using an extra spraying gun to apply more material to the top part of the lamp.

It has been found that the combination of absorbing medium and interference film of the electric lamp in accordance with the invention substantially preserves its initial properties throughout the service life of the electric lamp.

These and other aspects of the invention will be apparent from and elucidated with reference to the embodiment(s) described hereinafter.

In the drawings.

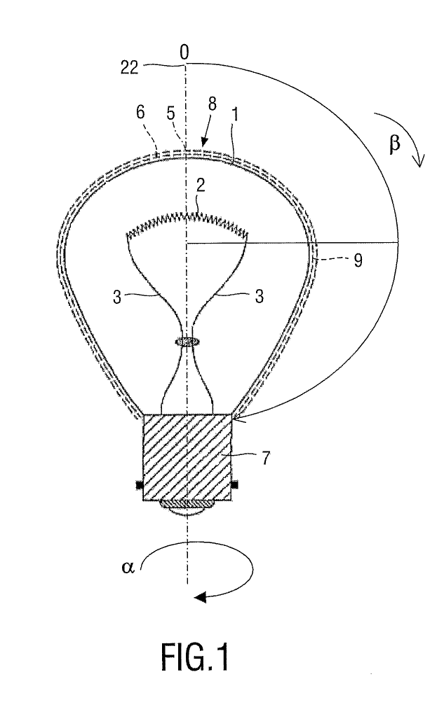

FIG. 1 is a cross-sectional view of an embodiment of the electric lamp in accordance with the invention.

FIG. 2 shows a variety of color points of a yellow colored lamp according to the state of the art.

FIG. 3 shows the influence of the number of reflections on the mirror on the transmission behavior for the light emitted by the lamp.

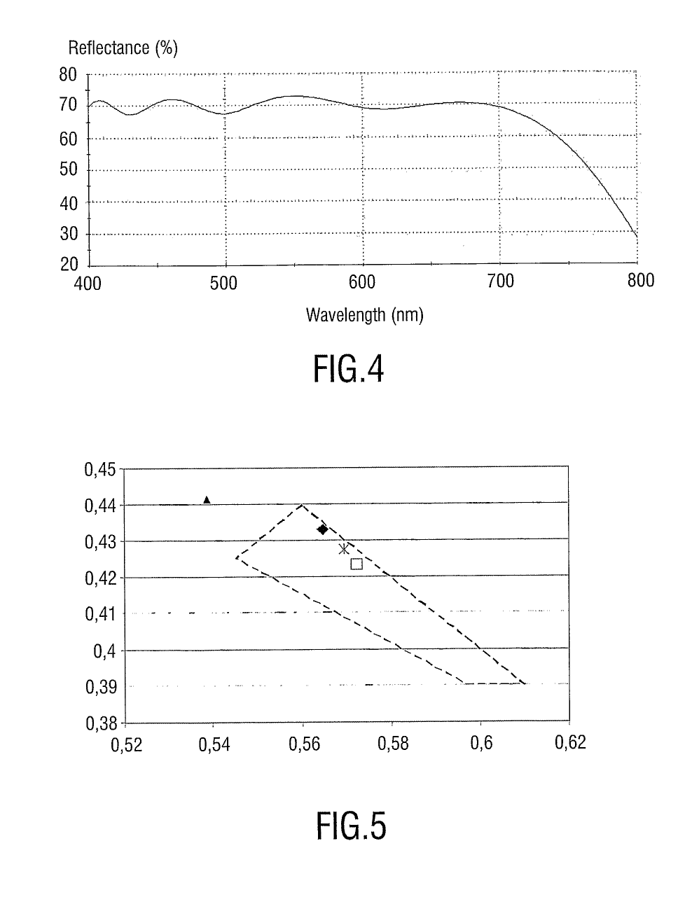

FIG. 4 shows the calculated reflection spectrum as a function of the wavelength of a 9 layer Nb₂O₅/SiO₂ interference film as shown in table I below.

FIG. 5 shows the color points of a known lamp and those of a lamp according to the invention with respect to X and Y co-ordinates in the 1931 CIE chromaticity diagram.

The Figs. are purely schematic and not drawn to scale. Particularly for clarity, some dimensions are exaggerated strongly.

FIG. 1 is a cross-sectional view of an embodiment of the electric lamp in accordance with the invention. The angle β is defined as indicated and is used to elucidate the behavior of the color of the emitted light as a function of angle. Said electric lamp has a light-transmitting lamp vessel 1, for example of glass, which is sealed in a gastight manner and which accommodates an electric element 2, in the Figure a (spiral-shaped) tungsten incandescent body, which is connected to current conductors 3 which issue from the lamp vessel 1 to the exterior. The lamp shown is filled with an inert gas, for example an Ar/N₂ mixture, having a filling pressure of approximately 1 bar.

In the embodiment of the electric lamp shown in FIG. 1, the light-absorbing medium is provided, in the form of a light-absorbing layer 6, on an outside of the lamp vessel 1 (on a wall of the lamp vessel), and an interference film 5 is provided on said light-absorbing layer. The light-absorbing layer 6 comprises, in this case, for example a layer of the pigment (in an MTMS matrix) referred to as chromophtal yellow in a layer thickness, which for example increases from 1.0 μm at the centre part 9 of the vessel to 2.5 μm at the top part (8) of the vessel. An electric lamp provided with such a light-absorbing medium emits, in operation, amber-colored light, the spectral transmission in the visible region exhibiting a transition from low transmission to high transmission in a wavelength range from approximately 500<λ<600 nm (the width of the wavelength range is approximately 100 nm). Such electric lamps can be used as an indicator lamp, for example, in indicators of vehicles. In an alternative embodiment of the layer, the light-absorbing layer 6 comprises chromophtal red A2B having a layer thickness of for example 1 μm at the center part (9), increasing to 3 μm at the top part (8). An electric lamp provided with such a chromophtal red A2B layer emits, in operation, red-colored light. Such electric lamps can be used as brake lights in vehicles, and their service life is at least about 1200 hours.

In FIG. 1, an interference film 5 is applied to the light-absorbing medium applied to the wall of the lamp vessel 1 (the “substrate” which interference film comprises layers of alternately a first layer of a material having a comparatively high refractive index (also see FIG. 1C), for example titanium oxide (average refractive index of TiO₂ approximately 2.4-2.8), niobium oxide (average refractive index of Nb₂O₅ approximately 2.3), tantalum oxide (average refractive index of Ta₂O₅ approximately 2.2) or zirconium oxide (average refractive index of ZrO₂ approximately 2.05), and a second layer of, predominantly, silicon oxide (average refractive index approximately 1.46). The TiO₂/SiO₂, Nb₂O₅/SiO₂ or Ta₂O₅/SiO₂ interference films preferably comprise only a small number of layers. Experiments have shown that said interference films preferably comprise at least 3 and at most approximately 17 layers. For example, an interference film having a desired average reflection of approximately R=50% requires approximately 6 optical layers stacked in accordance with the notation (HL)³ known to those skilled in the art, while, for example, a Nb₂O₅/SiO₂ interference film having a desired average reflection of approximately R=90%) requires approximately 15 layers stacked in accordance with the notation (HL)⁷H. As a result of the comparatively small number of layers, the manufacturing costs of such an interference film are comparatively low. It is of course clear to those skilled in the art that also other dielectric reflective mirrors can be used that are color neutral upon reflection and which might lead to higher emission.

FIG. 2 shows a variety of color points of a yellow colored lamp according to the state of the art for use as signal lamp in accordance with international traffic regulations with respect to X and Y co-ordinates in the 1931 CIE chromaticity diagram, given by the dotted line. The full square color points are measured from the top part of the lamp (left upper points) to the bottom part of the lamp (right lower points). It is shown that the color point distribution is not only very inhomogeneous, but that a number of points measured at the top part of the lamp even fall outside the required range.

FIG. 3 shows the influence of the number of reflections on the mirror on the transmission behavior for the light emitted by the lamp. The drawn line represents the transmission curve of the pure absorber applied as a 1 μm layer to the outside of a lamp. The short-dash line represents the transmission spectrum for the first pass through the filter. The long-dashed line represents the transmission after a large number of multiple reflections in the lamp.

### EXAMPLE

On a standard P lamp a yellow coating with a thickness of 1 μm (t_{abs}) is applied, containing a 9 layer interference filter on top if it, the filter having a reflectivity R over a large part of the visible spectral range of about 70% as depicted in FIG. 4. the filter is constructed of alternating layers of Nb₂O₅ and SiO₂ in the following way:

| | | Thickness |
|---|---|---|
| Layer | Material | (nm) |
| | Air | |
| 1 | Nb₂O₅ | 23 |
| 2 | SiO₂ | 62 |
| 3 | Nb₂O₅ | 56 |
| 4 | SiO₂ | 94 |
| 5 | Nb₂O₅ | 53 |
| 6 | SiO₂ | 90 |
| 7 | Nb₂O₅ | 82 |
| 8 | SiO₂ | 98 |
| 9 | Nb₂O₅ | 89 |
| | Substrate | |
| | (glass) | |

Application of the above light absorbing medium and interference film leads to a color point in the middle of the lamp of (x=0.5647, y=0.4328), shown as a solid square in FIG. 5. The color point at the top part of such a known lamp (for example a lamp referred to as PY21W), however is (x=0.5388, y=0.4412, shown as a solid triangle in FIG. 5), measured in the angle 0<β<30 degrees, which is far beyond the specified color requirements. In a lamp according to the invention however, the thickness of the light absorbing medium (in this case the yellow coating) at the top part (8) is made 2.5 times (2.5 μm) the thickness of the coating at the middle part of the lamp (9), resulting in a color point of (x=0.5645, y=0.4328, depicted as the asterisk in FIG. 5.) for the radiation emitted in the cone with semi angle β<30 degree. FIG. 5 shows that the color point of the top part of the lamp (8) is now even below that of the middle part (9). The open square in FIGS. 3 and 5 indicate an integrated color point measured with an Ulbricht sphere. This experiment shows that the color point distribution in a lamp according to the invention is significantly smaller than the color point distribution of a known lamp. For another position of the color point in the specified zone, the required thickness ratio might be different and must be determined separately. The best results are obtained with a thickness of the top part, which is between 1.5 and 3 times the thickness of the middle part for a 70% reflector.

1. An electric lamp comprising a light-transmitting pear shaped lamp vessel (1) with a top part (8) and a centre part (9) in which a light source (2) is arranged in the centre part, said electric lamp provided with a light-absorbing medium (6) exhibiting a spectral transition in the visible range, at least a part of the lamp vessel (1) being provided with an interference film (5), characterized in that the light absorbing-medium (6) provided at the top part of the vessel (8) has an absorption, which is 1.5 to 5 times the absorption of the light-absorbing medium provided at the centre part (9) of the vessel.

2. A lamp according to claim 1, wherein the light absorbing-medium (6) provided at the top part of the vessel (8) has a thickness which is 1.5 to 5 times the thickness of the light-absorbing medium provided at the centre part (9) of the vessel.

3. A lamp according to claim 1, wherein the thickness of the light-absorbing medium increases from the centre part (9) to the top part (8) gradually.

4. An electric lamp according to claim 1, wherein the reflection R of the interference film (5) lies in the range from 0.50<R<0.90.

5. A lamp according to claim 1, wherein the light source is a filament (2), arranged in a plane perpendicular to a central axis (22) through the vessel.
